(19) United States
(12) Patent Application Publication
(10) Pub. No.: US 2013/0113604 A1
(43) Pub. Date: May 9, 2013

(54) VALET REMOTE PAGING SYSTEMS AND METHODS

(71) Applicants: Matthew Marzec, San Diego, CA (US); Brett Littlewood, San Diego, CA (US)

(72) Inventors: Matthew Marzec, San Diego, CA (US); Brett Littlewood, San Diego, CA (US)

(21) Appl. No.: 13/289,243

(22) Filed: Nov. 4, 2011

(51) Int. Cl. G08B 5/22

(52) U.S. Cl. 340/7.21

(57) ABSTRACT

Systems and methods for valet and driver paging are disclosed. The valet paging system comprises a detachable driver device and a valet device. Both the driver and valet devices have transceivers which enable direct, two-way communication between the valet attendants and the drivers. Drivers and valet personnel are able to communicate requests for vehicle retrieval, indications that the vehicle has been retrieved, and acknowledgements that the driver has received valet messages.

### BACKGROUND OF THE INVENTION

1. Field of the Invention

The present invention relates in general to wireless communication paging systems. More particularly, the invention is directed to wireless valet paging systems and methods.

2. Description of the Related Art

Valet parking services provide many benefits to both drivers and business establishments such as hotels, restaurants, and event venues. Among the benefits include enhanced customer convenience and the ability for the valets to stack park a larger number of vehicles. Traditional valet services typically employ two paper tickets in which one ticket is given to the driver and the other corresponding ticket is attached to the vehicle key. When the driver wishes to retrieve the vehicle, the driver returns to the valet staging area and returns the ticket to the valet. However, this traditional approach requires drivers to wait for valet personnel to retrieve their vehicles. Moreover, this approach is prone to errors such as mismatching and misplacing tickets.

Accordingly, a need exists to improve valet parking services and methods.

### SUMMARY OF THE INVENTION

In the first aspect, a valet and driver paging system is provided. The valet and driver paging system comprises a first mobile device having a first transceiver and a first user interface, and a second mobile device configured for coupling with a vehicle key, the second mobile device having a second transceiver and a second user interface. The first and second mobile devices are configured for direct bi-directional communication between the first and second mobile devices.

In a first preferred embodiment of the valet and driver paging system, the first mobile device is preferably configured for receiving a vehicle retrieve indication from a driver of a vehicle requesting retrieval of the vehicle and transmitting a retrieve signal to the second mobile device, and the second mobile device is preferably configured for receiving the retrieve signal and generating a retrieve alert indication based on the received retrieve signal. The second mobile device is preferably configured for receiving a vehicle ready indication from a valet that the vehicle is ready for retrieval and transmitting a ready signal to the first mobile device. The first mobile device is preferably configured for receiving the ready signal and generating a ready alert indication based on the received ready signal.

The circuitry of the first mobile device is preferably substantially similar to the second mobile device. The first mobile device is preferably configured for physically coupling to the second mobile device. The first mobile device preferably further comprises a first set of one or more charging terminals. The second mobile device preferably further comprises a second set of one or more charging terminals. The first and second mobile devices are preferably configured for simultaneous electrical charging when the first and second mobile devices are physically coupled. The first mobile device preferably further comprises a mobile telephone. The first mobile device and the second mobile device each preferably further comprise a communication port and the communication port is preferably configured for modifying operating parameters of the first and second user interfaces. The first and second user interfaces preferably each comprises a display, a vibration device, and a sound emitting device.

In a second aspect, a valet and driver paging system is provided. The valet and driver paging system comprises a first mobile device having a first transceiver and a first user interface, and a second mobile device having a second transceiver and a second user interface. The first and second mobile devices are configured for direct bi-directional communication between the first and second mobile devices, and the first mobile device is configured for mating with the second mobile device.

In a second preferred embodiment, the first mobile device has a first set of charging terminals, the second mobile device has a second set of charging terminals. The first and second set of charging terminals are preferably electrically coupled when the first and second mobile devices are mated to enable the first and second mobile devices to be charged simultaneously.

The first mobile device is preferably configured for transmitting a retrieve signal to the second mobile device indicating that a driver of a vehicle requests the vehicle for retrieval. The second mobile device is preferably configured for generating a retrieve alert indication based on the received retrieve signal. The second mobile device is preferably configured for transmitting a ready signal to the first mobile device indicating that the vehicle is ready for retrieval. The first mobile device is preferably configured for generating a ready alert based on the received ready signal. The circuitry of the first mobile device is preferably substantially similar to the second mobile device. The first mobile device and the second mobile device each preferably further comprise a communication port. The communication port is preferably configured for modifying operating parameters of the first and second user interfaces.

In a third aspect, a method for wireless communication in a valet and driver paging system having a first mobile device and a second mobile device is provided. The method comprises providing a first mobile device having a first transceiver and a first user interface to a driver, providing a second mobile device configured for coupling with a vehicle key to a valet, the second mobile device having a second transceiver and a second user interface, and communicating bi-directionally between the first and second mobile devices.

In a third preferred embodiment, the method preferably further comprises synchronizing the first and second mobile devices to enable bi-directional communication between only the first and second mobile devices. The method preferably further comprises receiving a vehicle retrieve indication from the driver by the first mobile device that the driver is requesting retrieval of the vehicle, transmitting a retrieve signal from the first mobile device directly to the second mobile device, receiving the retrieve signal by the second mobile device, and generating a retrieve alert indication by the second mobile device.

The method preferably further comprises receiving a vehicle ready indication from the valet that the vehicle is ready for retrieval by the second mobile device, transmitting a ready signal from the second mobile device directly to the first mobile device, receiving the ready signal by the first mobile device,; and generating a ready alert indication by the first mobile device. The method preferably further comprises receiving an acknowledgement indication from the driver that the ready alert indication was acknowledged by the driver, transmitting an acknowledgement signal by the first mobile device, receiving the acknowledgement signal by the second mobile device, and generating an acknowledgement alert indication by the second mobile device.

These and other features and advantages of the invention will become more apparent with a description of preferred embodiments in reference to the associated drawings.

### DESCRIPTION OF THE DRAWINGS

FIG. 1 is a top, perspective view of a first preferred embodiment of a valet remote paging system having an upper driver mobile device coupled with a valet mobile device.

FIG. 2 is a top, perspective view of a second preferred embodiment of a valet remote paging system having an upper driver mobile device coupled with a valet mobile device.

FIG. 3 is schematic block diagram of a valet remote paging system having a valet device and a driver device.

FIG. 4 is schematic block diagram of a valet remote paging system having a valet device and a driver smart phone.

FIG. 5 is a flow chart illustrating an exemplary process for retrieving a vehicle employing a valet remote paging system.

FIG. 6 is a flow chart illustrating an exemplary process for generating a retrieve alert indication in the valet device in response to receiving a receive request by the driver device.

FIG. 7 is a flow chart illustrating an exemplary process for generating a ready alert indication by the driver device in response to receiving a ready for retrieval by the valet device.

### DETAILED DESCRIPTION OF THE PREFERRED EMBODIMENTS

The following preferred embodiments are directed to valet remote paging systems and methods. Such systems and methods may be employed by hotels, restaurants, stores, chauffeurs and any other venues which may involve cars, such as car parking and pickup services, car washes, car dealerships, auto shops, etc.

In one aspect, the valet paging system comprises a detachable driver device and a valet device. Both the driver and valet devices have transceivers which enable direct, two-way communication between the valet attendants and the drivers. When a driver arrives at a venue, the valet detaches the driver device from the valet device and gives the driver the driver device. The valet attaches the driver's key to the valet device, parks the vehicle, and locates the valet device within the valet's sight, sound or touch, such as by hanging on a board. When the driver wishes to retrieve the vehicle, the driver engages the user interface of the driver device such as by pressing a button for example. The driver device transmits a retrieve signal to the valet device. The valet device receives the retrieve signal and generates a retrieve signal alert indication to the valet by generating a sound, vibrating, or flashing a light to the valet for example. The valet retrieves the vehicle for the driver.

In another aspect, preferred embodiments of the valet paging system allow the valet device to transmit a ready signal to the driver device to inform the driver that the vehicle is ready for retrieval. The driver device receives the ready signal and generates a ready alert indication for the driver by generating a sound, vibrating, or flashing a light to the driver for example. The driver device then receives from the driver an indication that the ready signal was acknowledged by the driver. The driver device silences the ready alert signal and transmits an acknowledgement signal to the valet device. The valet device receives the acknowledgement signal and generates an acknowledgement alert indication. The driver retrieves the vehicle and returns the driver device to the valet.

In contrast, traditional valet parking systems employ paper tickets in which the driver is provided with a numbered ticket and the valet attaches the corresponding ticket to the driver's key and hangs the ticket and key on a board. When the driver wants to retrieve the vehicle, the driver returns to the valet staging area and hands the ticket to the valet. The valet removes the corresponding ticket and the vehicle key from the board, and the valet retrieves the vehicle while the driver waits.

Preferred embodiments offer several benefits over traditional valet parking systems. First, customer service is enhanced because the driver can continue to engage in the event while the vehicle is retrieved. Drivers will no longer have to wait for their vehicles at a valet station because they will be alerted when the vehicle is ready for retrieval. Moreover, a steady flow of traffic leaving the event is maintained because the drivers are not signaled until their vehicles are ready for retrieval. Furthermore, performance of valet personnel will improve because valet personnel can easily locate keys with reduced errors because the individual valet devices illuminate when signaled by the driver devices. Valet personnel will more effectively prepare the staging area without being rushed by impatient drivers. And finally, paper tickets will no longer be erroneously left on the driver's key ring or windshield.

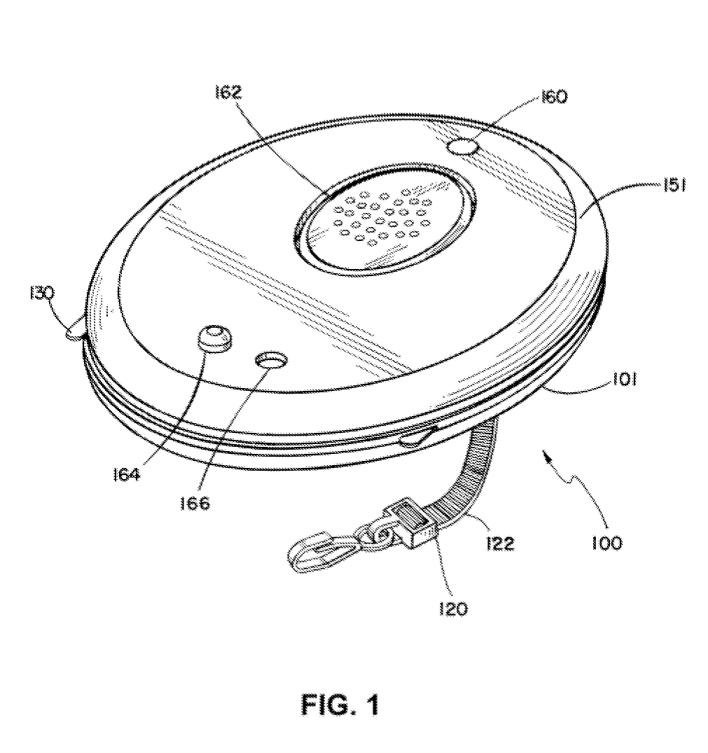

FIG. 1 is a top, perspective view of a first preferred embodiment of a valet remote paging system 100 having a driver mobile device 151 coupled with a valet device 101. The driver device 151 and the valet device 101 may, for example, be fabricated from molded high impact polymers and may display a customized logo. The driver device 151 and the valet device is preferably sized to fit conveniently in a pocket or purse, and may have a length of 2 inches or less and a width of 1.5 inches or less for example.

The driver mobile device 151 may be coupled to the valet device 101 back-to-back magnetically, mechanically, or by interlocking structures which snap together but allow for easy separation. The valet device 101 has a strap 122 which is connected to key clip 120 for securing the key to a vehicle. In an embodiment, key clip 120 comprises a retractable tab which can be placed through the key ring, looped around, and then attached to a lower section of the tab. The tab may be fabricated in material which may be detachably fastened such as hook and loop fasteners such as Velcro, or by other fastening means such as buckles or clips for example. The key clip will allow valet attendants to secure the vehicle key to the valet device 101 faster and easier as compared to traditional paper tickets. The valet device 101 has a Velcro tab 130 which may be employed to hang the valet device 101 from a board in the valet staging area. The valet device 101 may have a re-writable surface on which the valet may write the location of the vehicle. The re-writeable surface may be a sticker or may be a custom notepad which attaches to the valet device 101.

The driver device 151 has an LED 160 and a button 162. The driver may request that the vehicle be retrieved by pressing the button 162. Once the valet retrieves the vehicle, the valet device 101 transmits a signal to the driver device 151 which illuminates LED 160 to indicate that the vehicle is ready for retrieval for example. The LED 160 may have differing flashing sequences to relay specific messages.

The driver device 151 has a set of charging terminals 164 and 166 for recharging the driver device 151. The valet device 101 likewise has a set of charging terminals (not shown) which are electrically coupled to charging terminals 164 and 165 when the driver device 151 is coupled to the valet device 101 thus enabling the driver device 151 and the valet device 101 to be charged simultaneously. In an embodiment, multiple devices may be stacked together so that multiple devices may be charged simultaneously.

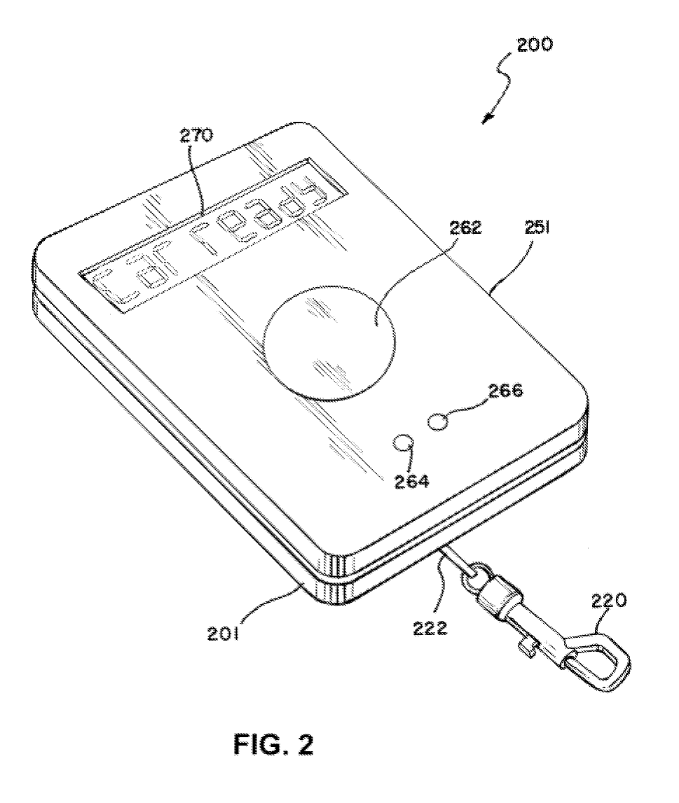

FIG. 2 is a top, perspective view of a second preferred embodiment of a valet remote paging system 200 having a driver device 251 coupled to a valet device 201. The driver device 251 may be coupled to the valet device 201 back-to-back magnetically, mechanically, or by interlocking structures which snap together but allow for easy separation. The valet device 201 has a strap 222 which is connected to key clip 220 for securing the key to a vehicle. In this non-limiting example, key clip 220 is a snap hook. However, other forms of fastening devices such as spring clips, harness clips, spring gate snaps, and pelican hooks are contemplated in one or more embodiments.

The driver device 251 has a button 262 and a display 270 which may indicate the status of the parked vehicle. The display 270 may present revolving sentences such as “Press Button to Retrieve Car” or “Car Ready.” The display 270 may be an LCD display, an LED display, a touch screen display, a retina display, or other types of displays for example. The driver device 251 has charging terminals 264 and 266 for recharging the driver device 251. The valet device 201 likewise has a set of charging terminals (not shown) which are electrically coupled to charging terminals 264 and 265 when the driver device 251 is coupled to the valet device 201 thus enabling the driver device 251 and the valet device 201 to be charged simultaneously.

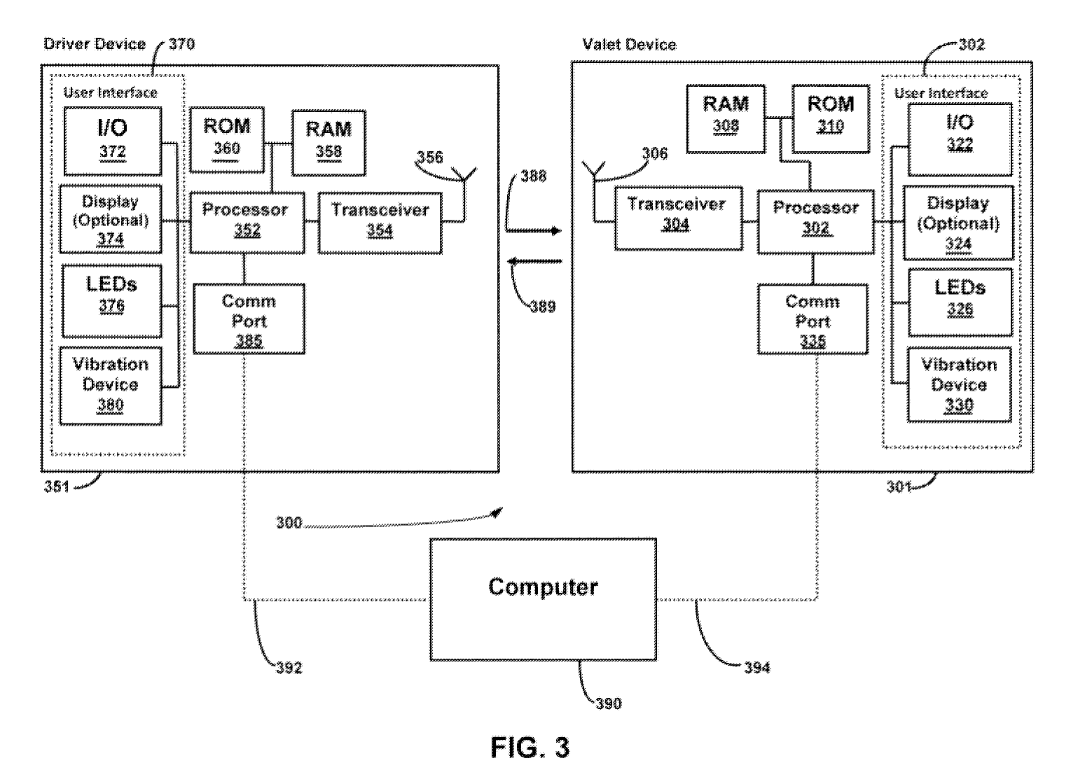

FIG. 3 is schematic block diagram of a valet remote paging system 300 having a driver device 351 (i.e., the first mobile device) and a valet device 301 (i.e., the second mobile device). The driver device 351 has a transceiver 354 and a user interface 370, and the valet device 301 has a transceiver 304 and a user interface 320. The driver device 351 and the valet device 301 are configured for direct bi-directional communication between the driver device 351 and the valet device 301 via radio frequency (“RF”) signals 388 and 389 transmitted and received by antennas 356 and 306 for example. The driver device 351 and the valet device 301 may transmit and receive short bursts of digital data. The digital data stream may include one or more of a data preamble, a command code, check bits, and/or a rolling or fixed code. The transceivers 304 and 354 preferably have coverage area extending to 0.25 miles or more and the ability to communicate in underground parking structures.

The circuitry of the driver device 351 may be substantially similar or identical to the circuitry of the valet device 301. This feature would decrease manufacturing costs and allow lost driver devices 351 or lost valet devices 301 to be readily replaced. In an embodiment, radio modules with integrated transceivers and antennas may be employed.

The user interface 370 of the driver device 351 may include one or more or a combination of LEDs 376, a vibration device 380, displays 374, and/or I/O components (“Input/Output”) 372 which may include sound emitting devices, lights, buttons, or touch screens for example. The user interface 320 of the valet device 301 may include one or more or a combination of LEDs 326, a vibration device 330, displays 334, and/or I/O components 332 which may include sound emitting devices, lights, buttons, or touch screens for example. The vibration devices 380 and 330 may be employed as an alerting mechanism when the driver device 351 or the valet device 301 receives a signal. The vibration devices 380 and 330 may be similar to the vibration devices employed by common cellular telephones. The vibration devices 380 and 330 may terminate vibration once the button in the I/O components 372 and 322 are pressed. The duration and form of the vibration pattern may either be a standard pattern or may be customizable.

The sound emitting devices generate sound or noise when signaled and may be in the form of beeping, ringing, or other sounds which may terminate emitting sound once a button in the I/O components 372 or 322 is pressed. The type of sound and the duration of the sound emission may be standardized or may be customizable. The LEDs 376 and 327 and other lights may illuminate upon receiving a signal. The LEDs 376 and 327 and other lights may terminate emitting light once a button in the I/O components 372 or 322 is pressed. The lighting pattern and the duration of the light emission may be standardized or may be customizable. During inactivity, the components will go into a sleep mode. Components will exit the sleep mode when the device receives a signal or a user engages the device. The time period to activate the sleep mode will either be standard or customizable.

In preferred embodiments, the driver device 351 and the valet device 301 may each have a communication port 385 and 335 respectively, where the communication ports 385 and 335 are configured for modifying operating parameters of driver device 351 and valet device 301. In an embodiment, a computer 390 sends control messages to the driver device 351 and the valet device 301 through lines 392 and 394 respectively. Lines 392 and 394 are coupled to the communication ports 385 and 335 which then interface with the processors 352 and 302. The software running on the computer 390 may program and customize the devices. Valet companies may customize the settings such as vibration (pattern and duration), sound (noise made, volume, and duration), lighting (pattern and duration) and sleep (time until sleep mode). The software will also be used to synchronize devices together and customize messages for LCD screen statuses. Among the parameters which may be modified include LED flashing rate, time periods for energizing the I/O components 372 and 308 features, and messages to be displayed on displays 374 and 324. Lines 392 and 394 may be in the form of serial interfaces or parallel buses.

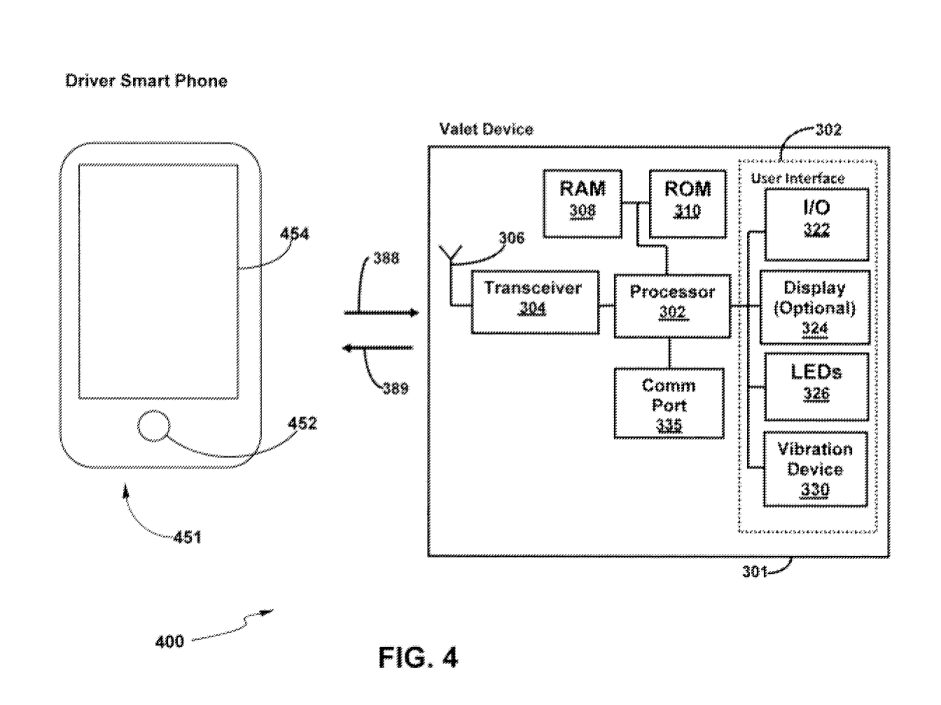

FIG. 4 is schematic block diagram of a valet remote paging system 400 having a valet device 301 and a driver smart phone 451. The driver smart phone 451 may have a button 452 and a touch screen display 454. A smart phone application, or mobile application, may be downloaded into the driver smart phone 451 which emulates the features of the driver device 351. This approach eliminates the need to provide a device to the driver. If the driver has said mobile application on his smart phone 451, the valet device 301 is synchronized directly to the phone 451 either electronically or through a corresponding code on the device. The driver smart phone 451 has a button or touch screen to signal the valet device 301 to indicate to the valet that the driver wants to retrieve his or her vehicle. When the valet activates the valet device 301, the phone 451 is signaled to indicate that the vehicle is ready.

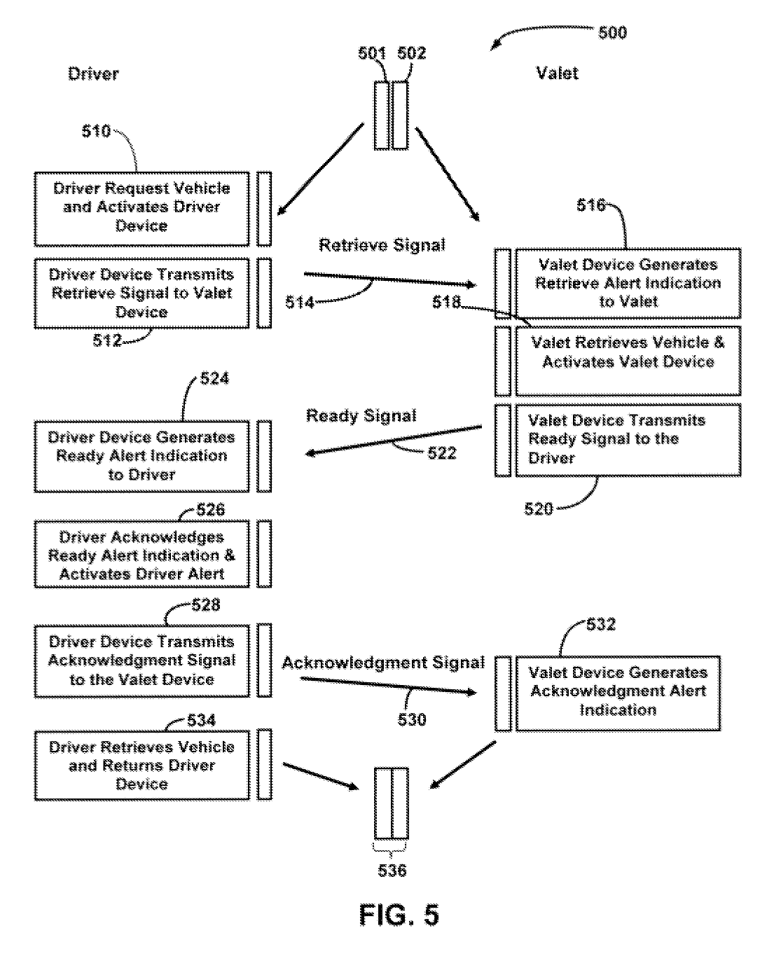

FIG. 5 is a flow chart illustrating an exemplary process 500 for retrieving a vehicle employing a valet remote paging system. The driver device 501 and the valet device 502 may be initially mated and then detached when a driver arrives. The devices 501 and 502 are decoupled, and the driver receives the driver device 501 and the valet attaches the vehicle key to the valet device 502. At a later time, the driver wishes to leave a venue and have the vehicle retrieved. The driver engages with the driver device 501 by such means as by pressing a button in the I/O components 372, pressing a touch screen display 374 as depicted in FIG. 3, or by interacting with the smart phone 451 as depicted in FIG. 4 for example (step 510). The driver device 501 receives the vehicle retrieve indication from the driver to have the vehicle retrieved and transmits a retrieve signal 514 to the valet device 502 (step 512). The valet device 502 receives the retrieve signal 514 and generates a retrieve alert indication to the valet (step 516). The retrieve alert indication may be in the form of illuminating one or more LEDs 326, presenting a message on display 324, or by energizing vibration device 330 as depicted in FIG. 3 for example.

The valet then retrieves the vehicle and engages with the valet device 502 by such means as by pressing a button in the I/O components 322, or by pressing a touch screen display 324 as depicted in FIG. 3 for example (step 518). The valet device 502 receives the vehicle ready indication from the valet and transmits a ready signal 522 to the driver device 501 (step 520). The driver device 501 receives the ready signal 522 and generates a ready alert indication to the driver (step 524). The ready alert indication may be in the form of illuminating one or more LEDs 376, presenting a message on display 374, or by energizing vibration device 380 as depicted in FIG. 3, or by displaying a message on the touch screen display 454 as depicted in FIG. 4 for example. The driver acknowledges the ready alert indication and activates the driver device 501 to terminate the alert indication (step 526). The driver device 501 receives an acknowledgement indication from the driver and transmits an acknowledgement signal 530 to the valet device 502 (step 528). The valet device 502 receives the acknowledgement signal 530 and generates an acknowledgement alert indication (step 532). The acknowledgement alert indication may be in the form of illuminating one or more LEDs 326, presenting a message on display 324, or by energizing vibration device 330 as depicted in FIG. 3 for example. The driver goes to the valet staging area, receives the vehicle, and returns the driver device 501 to the valet (step 534). The driver device 501 and the valet device 502 are re-coupled (step 536).

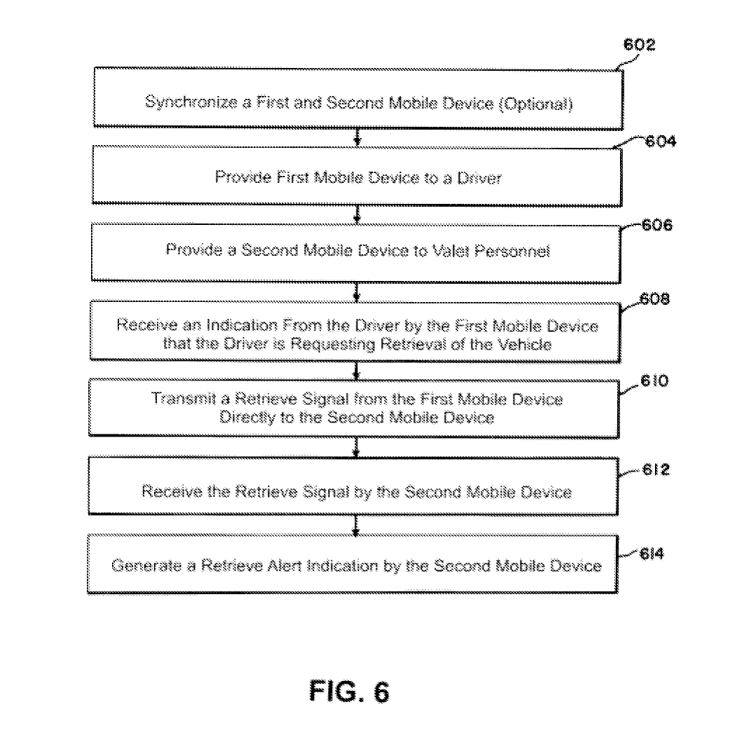

FIG. 6 is a flow chart illustrating an exemplary process for generating a retrieve alert indication in the valet device in response to receiving a receive request by the driver device. The first mobile device (i.e., such as driver device 502) and the second mobile device (i.e., such as valet device 501) may be synchronized at step 602. This synchronization may include transmitting and receiving a fixed code or a rolling code to enable bi-directional communication between only the first and second mobile devices. A first mobile device is provided which has a first transceiver and a first user interface to a driver (step 604). A second mobile device is provided to the valet personnel (step 606). The second mobile device is configured for coupling with a vehicle key and has a second transceiver and a second user interface. The first and second mobile devices are configured for bi-directional communication. The first mobile device receives an indication from the driver that the driver is requesting retrieval of the vehicle (step 608). The first mobile device transmits a retrieve signal directly to the second mobile device (step 610). The second mobile device receives the retrieve signal (step 612). The second mobile device generates a retrieve alert indication (step 614).

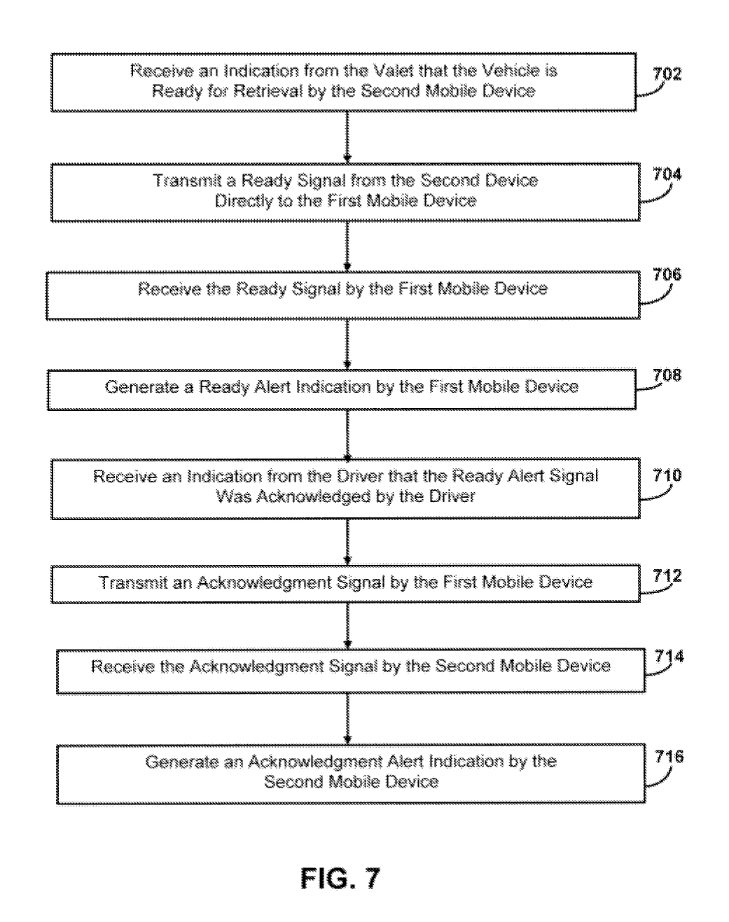

FIG. 7 is a flow chart illustrating an exemplary process for generating a ready alert indication by the driver device in response to receiving a ready for retrieval by the valet device. The second mobile device receives an indication from the valet that the vehicle is ready for retrieval (step 702). The second mobile device transmits a ready signal directly to the first mobile device (step 704). The first mobile device receives the ready signal (step 706). The first mobile device generates a ready alert indication for the valet (step 708). The first mobile device receives an indication from the driver that the ready alert indication was acknowledged by the driver (step 710). The first mobile device transmits an acknowledgement signal to the second mobile device (step 712). The second mobile device receives the acknowledgement signal (step 714). The second mobile device generates an acknowledgement alert indication.

Although the invention has been discussed with reference to specific embodiments, it is apparent and should be understood that the concept can be otherwise embodied to achieve the advantages discussed. The preferred embodiments above have been described primarily as valet parking systems and methods employing driver and valet devices having direct, bi-directional communication between the devices. Other preferred embodiments have been described primarily as systems and methods for communicating that a driver requests retrieval of the vehicle, and communicating that the valet has retrieved the vehicle for the driver. In this regard, the foregoing description of the valet remote paging systems and methods is presented for purposes of illustration and description. Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

What is claimed is:

1. A valet and driver paging system, comprising:
a first mobile device having a first transceiver and a first user interface; and,
a second mobile device configured for coupling with a vehicle key, the second mobile device having a second transceiver and a second user interface;
wherein the first and second mobile devices are configured for direct bi-directional communication between the first and second mobile devices.

2. The valet and driver paging system of claim 1, wherein:
the first mobile device is configured for receiving a vehicle retrieve indication from a driver of a vehicle requesting retrieval of the vehicle and transmitting a retrieve signal to the second mobile device; and,
the second mobile device is configured for receiving the retrieve signal and generating a retrieve alert indication based on the received retrieve signal.

3. The valet and driver paging system of claim 2, wherein:
the second mobile device is configured for receiving a vehicle ready indication from a valet that the vehicle is ready for retrieval and transmitting a ready signal to the first mobile device; and,
the first mobile device is configured for receiving the ready signal and generating a ready alert indication based on the received ready signal.

4. The valet and driver paging system of claim 1, wherein the circuitry of the first mobile device is substantially similar to the circuitry of the second mobile device.

5. The valet and driver paging system of claim 1, wherein the first mobile device is configured for physically coupling to the second mobile device.

6. The valet and driver paging system of claim 5, wherein:
the first mobile device further comprises a first set of one or more charging terminals;
the second mobile device further comprises a second set of one or more charging terminals; and,
the first and second mobile devices are configured for simultaneous electrical charging when the first and second mobile devices are physically coupled.

7. The valet and driver paging system of claim 1, wherein the first mobile device further comprises a mobile telephone.

8. The valet and driver paging system of claim 1, wherein:
the first mobile device and the second mobile device each further comprise a communication port; and,
the communication port is configured for modifying operating parameters of the first and second user interfaces.

9. The valet and driver paging system of claim 1, wherein the first and second user interfaces each comprises a display, a vibration device, and a sound emitting device.

10. A valet and driver paging system, comprising:
a first mobile device having a first transceiver and a first user interface; and,
a second mobile device having a second transceiver and a second user interface;
wherein the first and second mobile devices are configured for direct bi-directional communication between the first and second mobile devices, and the first mobile device is configured for mating with the second mobile device.

11. The valet and driver paging system of claim 10, wherein:
the first mobile device has a first set of charging terminals;
the second mobile device has a second set of charging terminals; and,
the first and second set of charging terminals are electrically coupled when the first and second mobile devices are mated to enable the first and second mobile devices to be charged simultaneously.

12. The valet and driver paging system of claim 10, wherein:
the first mobile device is configured for transmitting a retrieve signal to the second mobile device indicating that a driver of a vehicle requests the vehicle for retrieval; and,
the second mobile device is configured for generating a retrieve alert indication based on the received retrieve signal.

13. The valet and driver paging system of claim 12, wherein:
the second mobile device is configured for transmitting a ready signal to the first mobile device indicating that the vehicle is ready for retrieval; and,
the first mobile device is configured for generating a ready alert based on the received ready signal.

14. The valet and driver paging system of claim 10, wherein the circuitry of the first mobile device is substantially similar to the circuitry of the second mobile device.

15. The valet and driver paging system of claim 10, wherein:
the first mobile device and the second mobile device each further comprise a communication port; and,
the communication port is configured for modifying operating parameters of the first and second user interfaces.

16. A method for wireless communication in a valet and driver paging system having a first mobile device and a second mobile device, the method comprising:
providing a first mobile device having a first transceiver and a first user interface to a driver;
providing a second mobile device configured for coupling with a vehicle key to a valet, the second mobile device having a second transceiver and a second user interface; and,
communicating bi-directionally between the first and second mobile devices.

17. The method for wireless communication in a valet and driver paging system having a first mobile device and a second mobile device of claim 16, further comprising:
synchronizing the first and second mobile devices to enable bi-directional communication between only the first and second mobile devices.

18. The method for wireless communication in a valet and driver paging system having a first mobile device and a second mobile device of claim 16, further comprising:
receiving a vehicle retrieve indication from the driver by the first mobile device that the driver is requesting retrieval of the vehicle;
transmitting a retrieve signal from the first mobile device directly to the second mobile device;
receiving the retrieve signal by the second mobile device; and,
generating a retrieve alert indication by the second mobile device.

19. The method for wireless communication in a valet and driver paging system having a first mobile device and a second mobile device of claim 18, further comprising:
receiving a vehicle ready indication from the valet that the vehicle is ready for retrieval by the second mobile device;
transmitting a ready signal from the second mobile device directly to the first mobile device;
receiving the ready signal by the first mobile device; and,
generating a ready alert indication by the first mobile device.

20. The method for wireless communication in a valet and driver paging system having a first mobile device and a second mobile device of claim 19, further comprising:
receiving an acknowledgement indication from the driver that the ready alert indication was acknowledged by the driver;
transmitting an acknowledgement signal by the first mobile device;
receiving the acknowledgement signal by the second mobile device; and, generating an acknowledgement alert indication by the second mobile device.
